(19) United States
(12) Patent Application Publication
(10) Pub. No.: US 2020/0104418 A1
(43) Pub. Date: Apr. 2, 2020

(54) CUSTOMIZED SEARCH UTILIZING SOCIAL INFORMATION

(71) Applicant: International Business Machines Corporation, Armonk, NY (US)

(72) Inventors: Chang Lei, Shanghai (CN); Jing Cai, Shanghai (CN); Kun Yang, Beijing (CN); Jun Jie Yu, Shanghai (CN); Zhi Yong Xue, Shanghai (CN); Li Juan Chen, Zhangjiang (CN); Yahui Song, Zhangjiang (CN)

(21) Appl. No.: 16/144,026

(22) Filed: Sep. 27, 2018

(51) Int. Cl. G06F 17/30

(52) U.S. Cl. CPC G06F 17/30867; G06Q 50/01; G06F 17/30988; G06F 17/30946

(57) ABSTRACT

Method, computer program products, system are provided. A search request for a target object from a user is received. The request comprises at least one keyword and at least one Key Circle, wherein the at least one Key Circle includes at least one person selected by the user from a social network associated with the user. Based on the request, a search is conducted. Further, a result of the search is returned to the user, wherein the result includes at least one item that includes the target object related to both the at least one key word and the at least one Key Circle.

### BACKGROUND

The present invention generally relates to searches, and more specifically, relates to customized searches utilizing social information.

Search engines are widely used to provide search services which typically utilize one or more keywords to conduct a search. For a certain keyword or combination of keywords, returned search results may sometimes be in a very large number or contain many duplicates or similarities, which is very confusing and/or time-consuming to find the desirable ones. In the meantime, it can be difficult to identify from the search results which results may be more truthful, credible, and/or otherwise valuable.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter. This Summary also does not describe each illustrated embodiment or every implementation of the present disclosure.

In one illustrative embodiment of the present disclosure, there is provided a computer implemented method in which a search request for a target object from a user is received. The request comprises at least one keyword and at least one Key Circle, wherein the at least one Key Circle includes at least one person selected by the user from a social network associated with the user. Based on the request, a search is conducted. Further, a result of the search is returned to the user, wherein the result includes at least one item that includes the target object, the target object is related to both the at least one key word and the at least one Key Circle.

Other embodiments and aspects, including but not limited to, computer systems and computer program products, are described in detail herein and are considered a part of the claimed invention.

These and other features and advantages of the present invention will be described, or will become apparent to those of ordinary skill in the art in view of, the following detailed description of the example embodiments of the present invention.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure. Through the more detailed description of some embodiments of the present disclosure in the accompanying drawings, the above and other objects, features and advantages of the present disclosure will become more apparent, wherein the same reference numeral generally refers to the same components in the embodiments of the present disclosure.

FIG. 1 depicts a cloud computing node according to some embodiments of the present disclosure.

FIG. 2 depicts a cloud computing environment according to some embodiments of the present disclosure.

FIG. 3 depicts abstraction model layers according to some embodiments of the present disclosure.

FIG. 4 illustrates an example social network graph, in accordance with some embodiments of the present disclosure.

FIG. 5 illustrates a flowchart of an example method according to some embodiments of the present disclosure.

FIG. 6 illustrates an example user interface (UI) according to an embodiment of the present disclosure in which an example of a search request for a target object including a keyword ‘Steven’ and a selected Key Circle is shown.

FIG. 7 illustrates an example user interface (UI) according to an embodiment of the present disclosure in which another example of a search request for a target object including a keyword ‘T-shirt’ and a selected Key Circle is shown.

FIG. 8 illustrates an example of conducting a further search with an updated search request according to an embodiment of the present disclosure.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Some embodiments will be described in more detail with reference to the accompanying drawings, in which the embodiments of the present disclosure have been illustrated. However, the present disclosure can be implemented in various manners, and thus should not be construed to be limited to the embodiments disclosed herein.

Social network services (SNS) in recent years are becoming increasingly popular. Social network services allow individuals to connect with others through a mapping of relationships and can provide users with rich relationship information and a variety of other social information.

As mentioned above, search engines are widely used to provide search services and SNS is becoming more and more popular. There are many solutions that utilize social networks, such as various recommendation systems. Most of these systems analyze the opinions of experts or acquaintances of a user based on social information in order to provide optimized results as recommendations. However, these results are usually passively pushed and sometimes could not meet the user's requirements. In some cases, the user wishes to get search results from one or more acquaintances determined by the user, which may provide more accurate results that meet the user's requirements. For example, if a user prefers the dressing style of a certain acquaintance whom the user trusts or likes rather than one passively recommended by a system. Also, there are cases that the target object to be searched is fuzzy and/or difficult to describe in words, it will be more convenient if the user could refer to a certain acquaintance. For example, when the user searches for clothes on online shopping platforms, it can be more convenient if the user could directly refer to a certain acquaintance for associated purchase information instead of or in addition to describing the dressing style of the acquaintance in words. Existing approaches lack such solutions. Embodiments of the disclosure are targeting the problems aforementioned and provide a more customized and personalized search. To perform such a search, a user may subjectively select people from a social network associated with the user, which will be referred to herein as a “Key Circle” to use as an additional search input dimension. The search may be conducted further based on the Key Circle selected by the user subjectively from a social network associated with the user. This disclosure is not limited to embodiments using the term “Key Circle;” many other terms or phrases may describe this concept and are contemplated by this disclosure.

Embodiments of the disclosure can be deployed on cloud computer systems which will be described as follows. It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

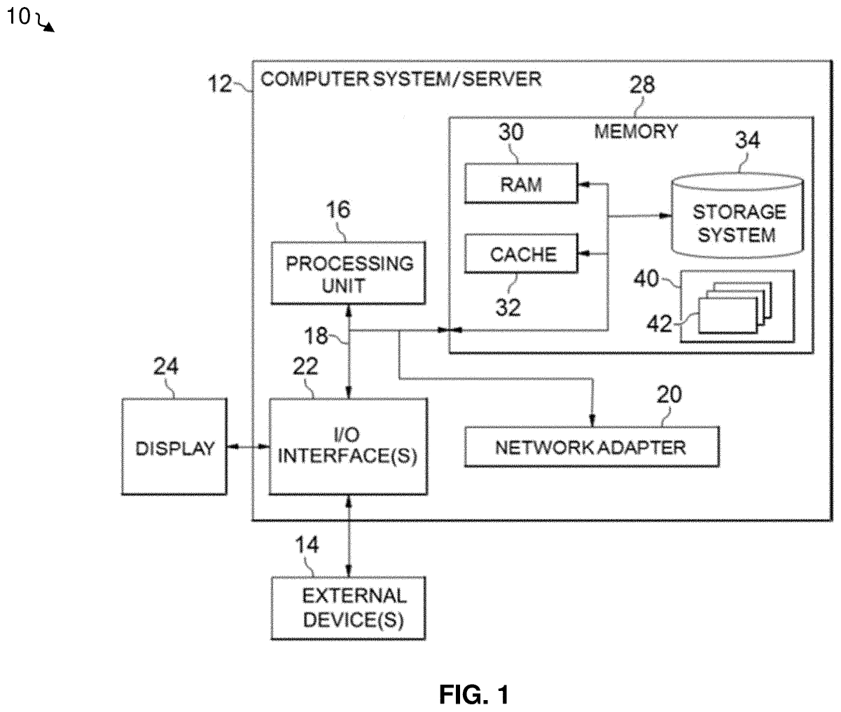

Referring now to FIG. 1, a schematic of an example of a cloud computing node 10 is shown according to some embodiments of the present disclosure. Cloud computing node 10 is only one example of a suitable cloud computing node and is not intended to suggest any limitation as to the scope of use or functionality of embodiments of the disclosure described herein. Regardless, cloud computing node 10 is capable of being implemented and/or performing any of the functionality set forth hereinabove.

In cloud computing node 10 there is a computer system/server 12 (which can be a portable electronic device such as a communication device), which is operational with numerous other general purpose or special purpose computing system environments or configurations. Examples of well-known computing systems, environments, and/or configurations that may be suitable for use with computer system/server 12 include, but are not limited to, personal computer systems, cell phones, tablet computers, personal digital assistants (PDA), server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, and Peripheral Component Interconnect Express (PCIe) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

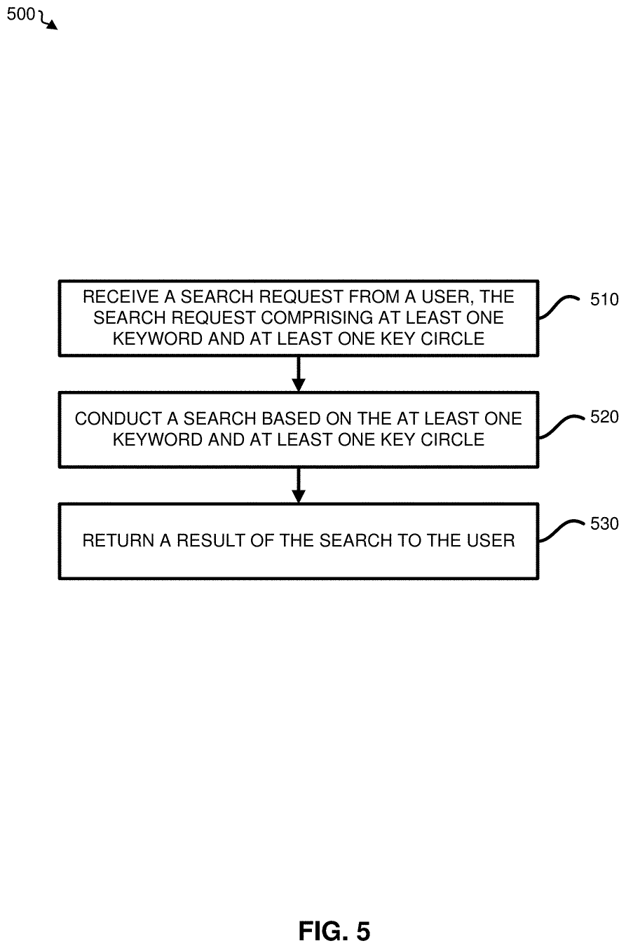

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the disclosure as described herein, including performing method 500 (described below regarding FIG. 5).

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

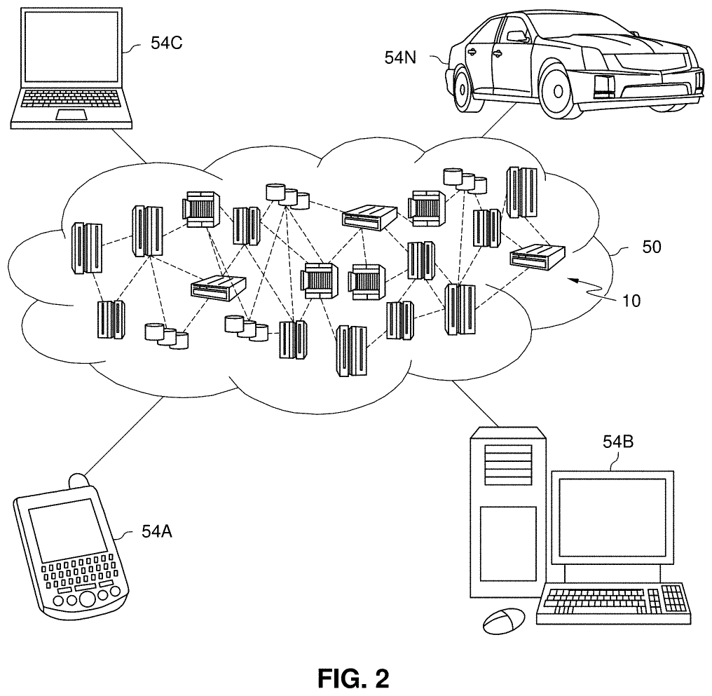

Referring now to FIG. 2, illustrative cloud computing environment 50 is depicted, according to some embodiments of the present disclosure. As shown, cloud computing environment 50 includes one or more cloud computing nodes 10 (such as depicted in FIG. 1) with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

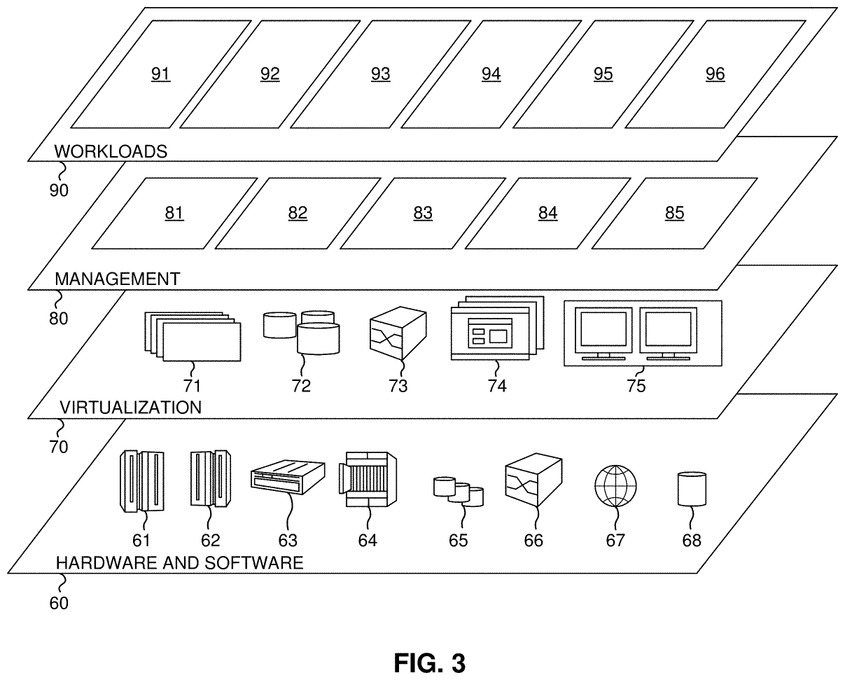

Referring now to FIG. 3, a set of functional abstraction layers provided by cloud computing environment 50 (FIG. 2) is shown, according to some embodiments of the present disclosure. It should be understood in advance that the components, layers, and functions shown in FIG. 3 are intended to be illustrative only and embodiments of the disclosure are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and search function 96 according to embodiments of the disclosure.

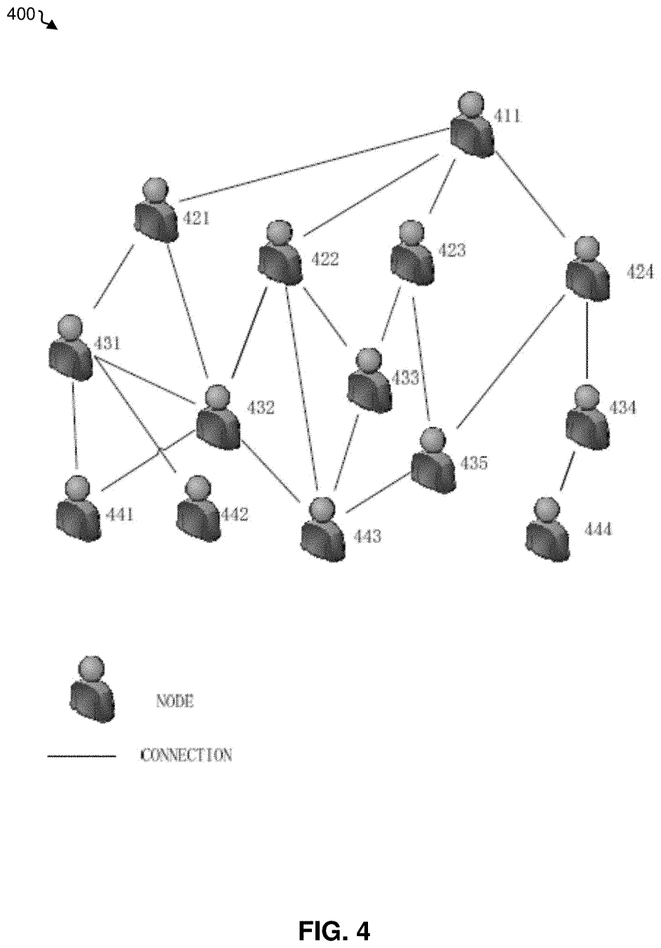

A social network service (SNS) is a communication-based sharing platform. Users of an SNS can connect to each other via one or more types of relationships (e.g., a mapping of a real social circle of a user), common interests among different users, same or similar behaviors among different users (e.g., likes or dislikes, purchase of a same or similar product), etc. The relationships of users may be presented as one or more social network graphs which will be discussed in detail in the following in accordance with FIG. 4. It should be pointed out that social network graph is merely a visual presentation of the relationship of SNS users, and any other proper ways to illustrate or coordinate this information may be utilized.

Referring now to FIG. 4, an example social network graph 400 in which various aspects of the disclosure may be implemented is shown. A social network graph represents a social network structure, and may be made up of interconnected nodes 411, 421-424, 431-435, and 441-444, with a root node 411 (or other centralized type of node) representing a user and each of other nodes 421-424, 431-435, and 441-444 representing a social acquaintance (or friend) found within the user's social circle. In other words, social acquaintances of the user may be represented by nodes within the user's social network at differing distances from the user node 411. For example, direct social acquaintances (e.g., those within the user's circle of social acquaintances) may be represented as nodes 421, 422, 423, and 424 that share a single edge with the user node 411, which may also be referred to as first-degree connections of the user. Additionally, indirect social acquaintances (e.g., social acquaintances of social acquaintances, or friends of friends) may be represented as nodes that share a single edge with the direct social acquaintances (denoted as nodes 421, 422, 423, and 424) or indirect social acquaintances (denoted as nodes 431, 432, 433, 434, 435, 441, 442, 443, and 444) rather than with the user node 411. Those which share a single edge with nodes defined as a first-degree connection can be referred to as a second-degree connection of the user, with examples of such nodes being 431, 432, 433, 434, and 435 in FIG. 4. Similarly, those which share a single edge with nodes referred to as a second-degree connection can be referred to as a third-degree connection of the user, with examples of such nodes being 441, 442, 443, and 444. Further degrees, including fourth-degree connections and beyond may exist, but are not shown herein for the sake of simplicity and any number of nodes may exists depending on how many social acquaintances the user 411 has and how many social acquaintances the social acquaintances of the user have in social networks. In the discussion so far, the user 411 has been referred to as the root node and degree connections were defined based on the root node 411. Degree connections may be defined based on any node and can be defined relative to that node. If taking the node 421 as a root node for an example, nodes 411, 431, and 432 may be defined as first-degree connections of the node 421, nodes 422, 423, 424, 441, 442, and 443 may be defined as second-degree connections of the node 421, and so on.

Also, the nodes in the example social network graph 400 have been discussed above as representing acquaintances of a user, but they may also or alternatively represent groups, entities, or organizations etc. For the purpose of simplicity, the remainder of the description herein will only use acquaintances as an example to describe embodiments of the present disclosure. The edges in the social network graph 400 may refer to any type of connections among the nodes, for example digital connections such as Internet, cellular network, private network, or traditional connections such as neighbors, friends, coworkers, etc.

Existing solutions such as a recommendation system considering social networks typically utilize the social network of a user, determined by the system based on the social network of the user. Therefore, the recommendation may be irrelevant and may not reflect the real needs of the user. For example, the user may consider opinions of acquaintances the user trusts or shares similar interests/tastes more rather than those acquaintances the user deems irrelevant to a topic to be searched. Existing solutions however fail to provide such functionalities.

Embodiments of the present disclosure provide such functionalities. Embodiments of the present disclosure provide the user abilities to subjectively select portions of a social network the user deems relevant, such as in a form of a contact list of the user generated based on a social network of the user (e.g. the social network graph shown in FIG. 4) and presented to the user for selection when the user conducts a search. The social network selected subjectively by the user can be referred to as a Key Circle, and the selected members in the Key Circle can be deemed more relevant to the real needs of the user for a to-be-conducted search. Compared to existing approaches, in which a user cannot subjectively select acquaintances the user trusts or shares similar interests/tastes as a further search dimension, embodiments of the present disclosure provide abilities for the user to subjectively select acquaintances the user trusts or shares similar interests/tastes to provide a more personalized search that can lead to a more accurate result that matches the true needs of the user. These improvements and/or advantages are a non-exhaustive list of example advantages. Embodiments of the present disclosure exist which can contain none, some, or all of the aforementioned advantages and/or improvements.

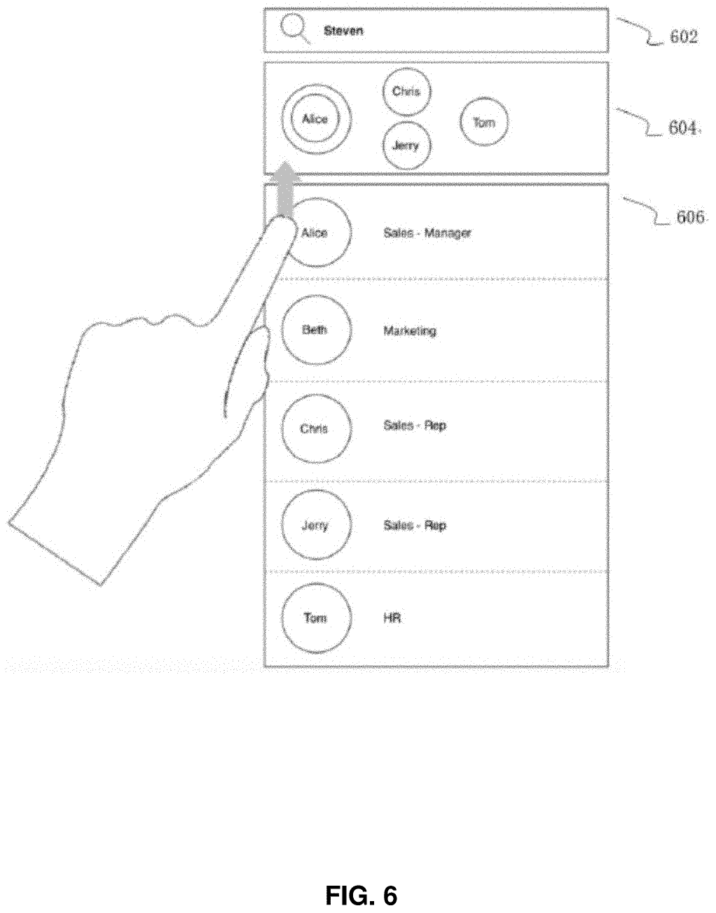

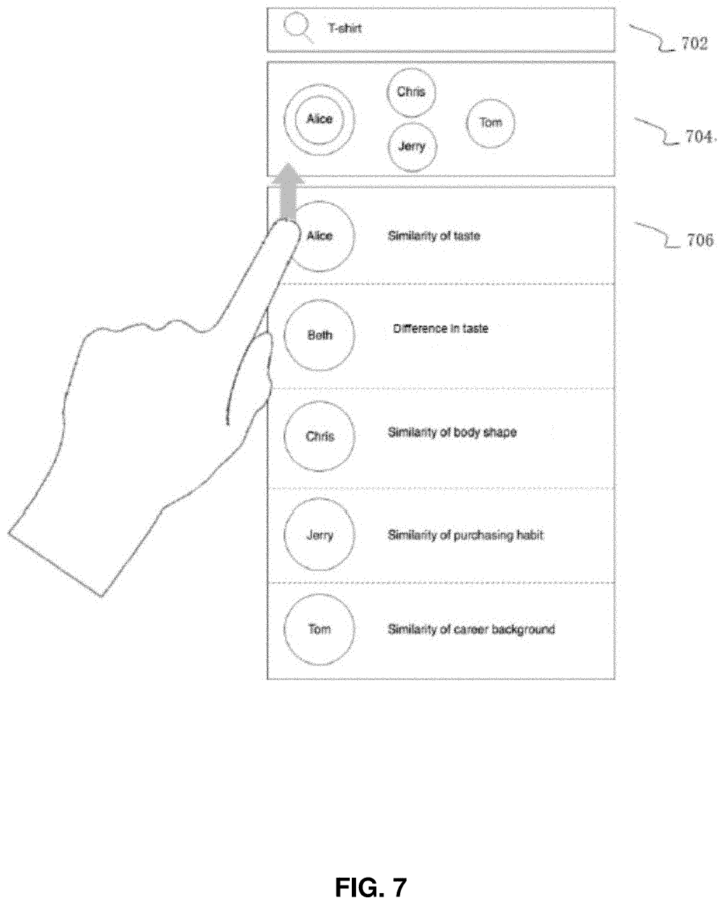

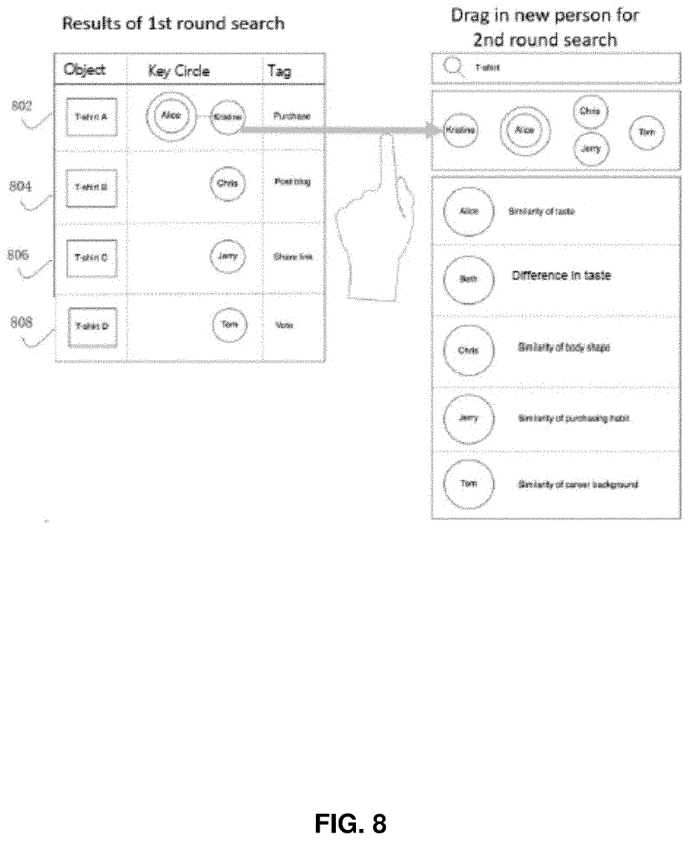

In the following, embodiments of the disclosure will be described in detail with reference to FIGS. 5 to 8. FIG. 5 illustrates an example method 500 according to some embodiments of the present disclosure, FIGS. 6 and 7 show example user interfaces (UI) according to embodiments of the present disclosure and FIG. 8 illustrates an example of conducting a further search with an updated search request according to an embodiment of the present disclosure.

Referring now to FIG. 5, a flowchart of an example method 500 according to some embodiments of the present disclosure is shown. The method 500 starts at 510 and continues through 530. At 510, a search request for at least one target object from a user is received. A target object may be a person, an item of merchandise, or any other item(s) the user wishes to search for. For example, in the example of FIG. 6, the target object is a colleague named Steven and in the example of FIG. 7, the target object is a T-shirt that meets the taste/requirement of the user. According to some embodiments of the present disclosure, the search request comprises at least one keyword (e.g. “Steven” in FIG. 6 or “T-shirt” in FIG. 7) and at least one Key Circle. The at least one Key Circle is selected by the user from a social network associated with the user. As aforementioned, the Key Circle can comprise people the user selected subjectively from a social network of the user and that the user deemed relevant. For example, the at least one Key Circle may include people selected by user, shown as “Alice”, “Chris”, “Jerry” and “Tom” in FIG. 6 or “Alice”, “Chris”, “Jerry” and “Tom” in FIG. 7. Compared with existing solutions, aside from a keyword which is typically used in a traditional search, an additional search dimension named Key Circle which comprises people selected by the user from a social network associated with the user is further utilized. People in the Key Circle are selected by the user subjectively rather than pre-determined by a system.

The target object may be, for example, a person, a merchandise, a service etc. Embodiments of the present disclosure can be extremely useful for scenarios where a user wants to search for a target object which may be difficult describe in words and the user knows someone that the user trusts or shares similar interests/tastes so that the user could refer to. For example, the user wants to search out a colleague named Steven; however, the user only knows Alice, Chris, Jerry or Tom may work in the same team (example of FIG. 6). For another example, the user may want a dress which has a style similar to an acquaintance of the user, e.g., Alice. With embodiments of the present disclosure, a further dimension called herein “Key Circle” comprising people selected by the user subjectively is utilized so that the target object can be searched for even if the target object is difficult to describe in words. However, the concepts, method, system, and computer program product discussed herein are not limited to situations where the target object is difficult to describe in words.

According to some embodiments of the present disclosure, a contact list may be provided to the user, and the at least one Key Circle can be selected from the contact list. This can occur for example, before block 510 of method 500 such that the user can select the Key Circle as part of the search request. It can also occur after 510 such that the user is prompted to add the Key Circle to the search request received from the user. As aforementioned, the contact list may be generated based on the social network graph of the user shown in FIG. 4. According to some embodiments of the present disclosure, the contact list may be provided to the user via a user interface (UI). The user interface (UI) displaying the contact list may be in any form, such as a table (e.g. the tables shown in FIGS. 6 to 8), a graph (for example, a graph similar to the graph in FIG. 4), or blocks, etc. The order of entries in such a UI can be alphabetical as shown in the examples in the figures or can be arranged in various other manners (such as frequency of use in Key Circles, degree of connection, etc.) and may be sortable or otherwise arrangeable through user customization.

According to some embodiments of the present disclosure, the at least one Key Circle and/or the at least one person in the at least one Key Circle can be assigned with a weight, for example a connection degree, a priority etc., and the weight may be adjusted dynamically. According to some embodiments of the present disclosure, the user interface (UI) displaying the contact list to the user can also provide the user the ability to add weights to the at least one Key Circle and/or the at least one person in the at least one Key Circle. For example, the number of the circles on each node can represent the connection degree, and the order of the nodes represents the priority, as shown in FIGS. 6 and 7 with “Alice” having two circles and the other people having one circle. It should be pointed out that any formats may be used to represent weights other than those shown in FIGS. 6 and 7 and many such formats can be envisioned by a person of skill in the art.

According to some embodiments of the present disclosure, an extended contact list may be provided to the user, wherein the at least one Key Circle may be further selected from the extended contact list. The extended contact list may comprise people in extended connections in the social network of the user, e.g. second-degree connections and so on. In some embodiments, the contact list can automatically update as the user adds people to the Key Circle. This may occur if for example, the user has previously chosen two or more people together and may be useful to the user in selecting the same or similar group again.

After receiving the search request from the user at 510, the method 500 proceeds to 520, in which a search is conducted based on the received search request. As mentioned above, the search request can comprise at least one keyword and at least one Key Circle. For example, when the search is conducted, data in the social network associated with the people in the Key Circle is assessed and searched. Data in the social network comprises but not limits to user behavior data and objects, merchandise, services or other potential target objects relating to the user behavior data: such as user posts, user votes, user logs, user comment, user bookmarks, user purchases, and user browsing history etc. These data can be automatically collected through specific technologies: such as crawling through a crawler and/or calling the API of the SNS website to obtain the desired information. These technologies are existing technology and will not be described in detail herein. The data may be maintained/stored in the cloud, such as in FIG. 3 workload layer 90, so that they could be achieved/searched rapidly when the various embodiments of the present disclosure are implemented.

Then, the method 500 proceeds to 530, in which a result of the search is returned to the user, wherein the result includes at least one item which is potentially the target object that is related to both the at least one key word and the at least one Key Circle. The returning of the result can include displaying the result on a user interface. In some embodiments, the results can be displayed using a user interface such as that shown in FIG. 8 and described below in more detail. Such a display can enable a user to easily modify the at least one key word and the at least one Key Circle, and conduct a subsequent search using the modified at least one key word and at least one Key Circle. The method 500 then ends.

According to some embodiments of the present disclosure, the user may update the search request by adjusting the at least one Key Circle. According to some embodiments of the present disclosure, the people in the at least one Key Circle and/or the weight of the at least one Key Circle and/or the at least one person in the at least one Key Circle may be adjusted iteratively and/or dynamically, in order to obtain more desired results.

According to some embodiments of the present disclosure, upon receiving the updated search request, a further search can be conducted based on the updated search request and the social network associated with the user. By updating the search request with such adjustments and conducting a further search, the user can obtain different results which may be more suited to the target object the user sought.

According to some embodiments of the present disclosure, the result may be ordered according to the weight of the at least one Key Circle and/or the weight of the at least one person in the at least one Key Circle.

According to some embodiments of the present disclosure, each item of the search result comprises: the target object, the at least one Key Circle, and tag information representing the relationship between the target object and the at least one Key Circle.

In the above, embodiments of the present disclosure were described in detail with reference to the example method 500 shown in FIG. 5. Referring now to FIG. 6, in which an example user interface (UI) according to an embodiment of the present disclosure in which an example of a search request for a target object including a keyword ‘Steven’ and a selected Key Circle is shown. In the UI shown in FIG. 6, there are fields shown of a key word input field 602, a Key Circle input field 604, and a contact list field 606. The key word input field 602 and the Key Circle input field 604 are provided for the user to input at least one key word and at least one Key Circle. The contact list field 604 presents the user a contact list generated by system based on the social network of the user, and the user may select people from the contact list as people in the Key Circle. In this example, the keyword is ‘Steven’, and the Key Circle is the list of people comprising Alice, Chris, Jerry, and Tom shown in the Key Circle input field 604. In the contact list field 606, job roles of the contacts are provided, which may occur automatically depending on the search term entered or by user request. In the example of FIG. 6, the user knows that Alice is the sales manager and may be the most probable one to know Steven and the user may have Alice be ranked first and dragged into the Key Circle field in the front. Additionally, Alice is also marked with a double-circle shape, which can occur e.g. by a double click or other inputs, and/or could mean the user desires to include Alice's first-degree social connections in the Key Circle. Herein, though Alice is selected as a person, Alice herself represents a Key Circle. In the example of FIG. 6, the user may know that Chris and Jerry are sales representatives and may be the next most probable people to know Steven, so they are placed after Alice with the same weight as each other. Finally, Tom may be from HR and could be the third most probable one to know Steven, so he is placed by the user after Chris and Jerry. In this example, one circle means only the node selected is brought in, two circles mean the node as well as its first-degree connections will be brought in, and so on. The format shown in FIG. 6 is merely an example, any other formats such as underline, block, etc. may be used to represent inclusion of additional connections. In some embodiments, for example a third circle could indicate that both first and second-degree connections of the circled user will be used, etc. In FIG. 6, the order of the nodes represents the weight, however any other formats may be used. In some embodiments, weights may be numerically applied or otherwise indicated beyond an ordering. For example, due to likelihood of knowing Steven, Alice could be weighted 10, Chris and Jerry could be weighted 6, and Tom could be rated 3. Also, while only one Key Circle is shown in FIG. 6, there may be more Key Circles.

Referring now to FIG. 7, illustrated is an example user interface (UI) according to an embodiment of the present disclosure in which another example of a search request for a target object including a keyword ‘T-shirt’ and a selected Key Circle is shown. In the UI shown in FIG. 7, a key word input field 702, a Key Circle input field 704, and a contact list field 706 are shown. The key word input field 702 and the Key Circle input field 704 are provided for the user to input at least one key word and at least one Key Circle. The contact list field 704 presents the user a contact list generated by system based on the social network of the user, and the user may select people from the contact list as people in the Key Circle. In this example, the keyword is ‘T-shirt’, and the Key Circle is the list of people comprising Alice, Chris, Jerry, and Tom as shown in the Key Circle input field 704. In the contact list field 706, descriptions of the contacts relevant attributes are provided, which may occur automatically depending on the search term entered or by user request. In the example of FIG. 7, the user may know that Alice has the most similar dressing taste as the user, so the user may rank Alice first and be dragged into the Key Circle field in the front. Additionally, Alice is also marked with a double-circle shape, which can occur e.g. by a double click or other inputs, and/or could mean the user desires to include Alice's first-degree social connections in the Key Circle. Herein, though Alice is selected as a person, Alice herself represents a Key Circle. In the example of FIG. 6, the user may know that Chris and Jerry either have similar body shape or purchasing habit with the user, so they are placed after Alice with the same weight as each other. Finally, Tom may have a similar career background with the user and can be placed after Chris and Jerry. In this example, one circle means only the node selected is brought in, two circles mean the node as well as its first-degree connections will be brought in, and so on. The format shown in FIG. 7 is merely an example, any other formats such as underline, block, etc. may be used to represent inclusion of additional connections. In some embodiments, for example a third circle could indicate that both first and second-degree connections of the circled user will be used, etc. In FIG. 7, the order of the nodes represents the weight, however any other formats may be used. In some embodiments, weights may be numerically applied or otherwise indicated beyond an ordering. For example, due to likelihood of knowing Steven, Alice could be weighted 10, Chris and Jerry could be weighted 6, and Tom could be rated 3. Also, while only one Key Circle is shown in FIG. 7, there may be more Key Circles.

Referring now to FIG. 8, illustrated an example of conducting a further search with updated search request according to some embodiments of the present disclosure. In the left, the result of a first-round search is shown in FIG. 8. The search result comprises items 802, 804, 806, and 808. Each item comprises the target object, the related Key Circle and tag information. For example, item 802 comprises the target object “T-shirt A”, the related Key Circle or member of the Key Circle used in the search: “Alice”, “Kristine,” and the tag information “Purchase.” In this example, “Kristine” is shown connected to “Alice” representing that she is a first-degree contact of “Alice” who was included in the Key Circle due to her connection to “Alice,” as discussed above regarding double circles in FIGS. 6 and 7.

In this example, the user wants to perform another search to get a target object that matches the needs of the user even better. To do so, the user can drag in new people to update the Key Circle for a second-round search, as shown in the right in FIG. 8. The user can drag in Kristen to the Key Circle as the result from Kristen satisfies the needs of the user although the user doesn't know Kristen. Based on the updated search request, a new search can be conducted and result can be returned (not shown). Search refinement is not limited to this example embodiment and can include changing weights of members of the Key Circle, removing members of the Key Circle, changing the search term, adding additional search terms, or any other customization of the search in accordance with the teachings of this disclosure.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer implemented method, comprising:
receiving a search request for a target object from a user, the request comprising at least one keyword and at least one Key Circle, wherein the at least one Key Circle includes at least one person selected by the user from a social network associated with the user;
conducting a search based on the request; and
returning a result of the search to the user, wherein the result includes at least one item that includes the target object, wherein the target object is related to both the at least one key word and the at least one Key Circle.

2. The method of claim 1, further comprising:
providing a contact list to the user, wherein the at least one Key Circle is selected from the contact list.

3. The method of claim 2, wherein the contact list comprises at least one extended contact list, and wherein the extended contact list includes one or more person who has a second-degree relationship with the user.

4. The method of claim 1, wherein the at least one item comprises:
the target object;
the at least one Key Circle; and
tag information representing the relationship between the target object and the at least one Key Circle.

5. The method of claim 1, wherein the at least one Key Circle and/or the at least one person in the at least one Key Circle is assigned a weight, and the weight is adjustable dynamically.

6. The method of claim 5, wherein the result is ordered according to the weight of the at least one Key Circle and/or the at least one person in the at least one Key Circle.

7. The method of claim 1, further comprising:
receiving an updated search request, wherein the at least one Key Circle in the updated search request is adjusted by the user,
conducting a further search based on the updated request.

8. A computer program product comprising a computer readable storage medium having a computer readable program stored therein, wherein the computer readable program, when executed on a computing device, causes the computing device to:
receive a search request for a target object from a user, the request comprising at least one keyword and at least one Key Circle, wherein the at least one Key Circle includes at least one person selected by the user from a social network associated with the user;
conducting a search based on the request; and
returning a result of the search to the user, wherein the result includes at least one item that includes the target object, wherein the target object is related to both the at least one key word and the at least one Key Circle.

9. The computer program product of claim 8, wherein the computer readable program further causes the computing device to:
provide a contact list to the user, wherein the at least one Key Circle is selected from the contact list.

10. The computer program product of claim 9, wherein the contact list comprises at least one extended contact list, and wherein the extended contact list includes one or more person who has a second-degree relationship with the user.

11. The computer program product of claim 8, the at least one item comprises:
the target object;
the at least one Key Circle; and
tag information representing the relationship between the target object and the at least one Key Circle.

12. The computer program product of claim 8, wherein the at least one Key Circle and/or the at least one person in the at least one Key Circle is assigned a weight, and the weight is adjustable dynamically.

13. The computer program product of claim 11, wherein the result is ordered according to the weight of the at least one Key Circle and/or the at least one person in the at least one Key Circle.

14. The computer program product of claim 8, wherein the computer readable program further causes the computing device to:
receiving an updated search request, wherein the at least one Key Circle in the updated search request is adjusted by the user,
conducting a further search based on the updated request.

15. A system, comprising:
a processor; and
a memory coupled to the processor, wherein the memory comprises instructions which, when executed by the processor, cause the processor to:
receive a search request for a target object from a user, the request comprising at least one keyword and at least one Key Circle, wherein the at least one Key Circle includes at least one person selected by the user from a social network associated with the user;
conducting a search based on the request; and
returning a result of the search to the user, wherein the result includes at least one item that includes the target object, wherein the target object is related to both the at least one key word and the at least one Key Circle.

16. The system of claim 15, wherein the instructions further cause the processor to:
provide a contact list to the user, wherein the at least one Key Circle is selected from the contact list.

17. The system of claim 16, wherein the contact list comprises at least one extended contact list, and wherein the extended contact list includes one or more person who has a second-degree relationship with the user.

18. The system of claim 17, wherein the at least one item comprises:
the target object;
the at least one Key Circle; and
tag information representing the relationship between the target object and the at least one Key Circle.

19. The system of claim 15, wherein the at least one Key Circle and/or the at least one person in the at least one Key Circle is assigned a weight, and the weight is adjustable dynamically.

20. The system of claim 15, wherein the result is ordered according to the weight of the at least one Key Circle and/or the at least one person in the at least one Key Circle.
